(19) United States
(12) Patent Application Publication
(10) Pub. No.: US 2022/0177643 A1
(43) Pub. Date: Jun. 9, 2022

(54) Method for Preparing High Molecular Weight Polybutylene Succinate

(71) Applicant: Ningbo DOU Chemical Co., Ltd., Ningbo (CN)

(72) Inventors: Herui Dou, Ningbo (CN); Xiaohang Xu, Ningbo (CN); Rong Lv, Ningbo (CN)

(73) Assignee: Ningbo DOU Chemical Co., Ltd.

(21) Appl. No.: 17/247,333

(22) Filed: Dec. 8, 2020

(51) Int. Cl. C08G 63/85

(52) U.S. Cl. CPC C08G 63/85

(57) ABSTRACT

A method for preparing high molecular weight polybutylene succinate includes: (a) using maleic anhydride (MAH) and C1-C4 alcohols to produce dialkyl maleates and water, in which dialkyl fumarate is calculated as dialkyl maleate of an equivalent mole. A reactive distillation process is used for the purification and obtains dialkyl maleates; (b) selective hydrogenation of those dialkyl maleates in the presence of high pressure hydrogen to produce the corresponding dialkyl succinates; (c) condensation of dialkyl succinates with mostly 1,4-butanediol (BDO) and other aliphatic diols to produce high molecular weight polybutylene succinates by adding catalysts. Compared with the existing technologies, the present procedure uses a new source of raw bulk feedstocks, and circumvents or overcomes problems associated with the acidic monomer's corrosiveness, excessive formation of by-products, low yields of desired products and the relatively low molecular weight of the polybutylene succinate produced by existing technologies.

### TECHNICAL FIELD OF THE INVENTION

The present invention relates to the technical field of preparation of biodegradable polymers, in particular to a method for preparing high molecular weight polybutylene succinate (PBS).

### BACKGROUND OF THE INVENTION

Plastics are widely used for various industrial applications and in our daily life for their superb and versatile performance, low density, relatively simple manufacturing and processing, and low prices. However, huge quantities of waste plastics produced worldwide have been causing severe environmental problems, making their disposal a global hazard. For example, 100 kilograms of plastic wastes are produced annually per person in Western Europe, while in China, this amounts to 20 kg per year per person. Even after recycling and reuse of these wastes, the weight of plastic products disposed globally has exceeded 70 million tons, among which China contributes to more than 4 million tons per year. Horrendous pollution is caused by landfilling and incineration of these plastic wastes. Therefore, there is an increasing consciousness worldwide for the development of degradable plastics to mitigate the plastic pollution. Developed countries and regions, such as the United States, the European Union and Japan, are current forerunners in this field. Although they do not ban traditional plastic products, they do place more stringent regulations and restrictions on the recycling and reuse of the nondegradable plastics. In addition, stringent bans on the use of nondegradable products are being put forward and enforced. Particularly, plastic products that come into direct contact with food, human body and medicine must be manufactured only with biodegradable plastics, and traditional nondegradable plastics are to be disallowed in those scenarios. These countries also strongly promote the use of degradable plastics in specific application areas where recycling of plastics is difficult or costly.

Prior to 2018, in order to reduce their own pollution and cut down on recycling costs, a number of countries including the US, EU, Japan, Korea and Australia exported and shipped huge quantities of plastic wastes to less developed regions in the world. At that time, China, India and Egypt ranked as the first three countries that imported these wastes, collectively accounting for over 90% of the global import of plastic wastes. Since the 1st of January in 2018, however, China has waged a war against these ‘alien’ wastes, followed by a similar campaign in India to ban the import of wastes including solid plastics from March of 2019. The bans on plastic waste import by China and India have greatly shaken the existing systems for the use and recycling of plastics in the abovementioned developed countries, pushing them to issue various bans on plastics. In addition to reinforcing the domestic recycling and reuse of traditional plastics, they also supplemented and expanded their incineration facilities to burn plastic wastes. In the meantime, they have kept issuing and enforcing policies and laws to promote the use of degradable plastics and offer subsidies. It is therefore foreseeable that the development of degradable plastics is moving to the fast track, globally and also for China.

On the 16th of February, 2019, Hainan province issued an implementation plan for total prohibition of the production, sales and use of single-use nondegradable plastic products within the entire province. Considering the current situation, a time limit is set: by the end of 2025, the production, trade and use of all plastic products listed in the “Prohibited items of single-use non-degradable plastic products in Hainan Province” will be entirely banned. Hainan province as a pilot made the first move toward the ultimate phase-out of non-degradable plastics and it is expected that other provinces will soon follow its footstep, ushering in a perfect window of opportunity for the degradable plastics industry in China.

Degradable plastics, or biodegradable plastics, are plastics that can be broken down by microorganisms (bacteria or fungi) into water, carbon dioxide and some bio-material. These degradable polymers/plastic materials can be classified into the following three major categories, based on their compositions and manufacturing processes: naturally produced renewable polymers, synthetic polymers derived from renewable resources, and synthetic polymers derived from petroleum-based resource. Some of primarily used biodegradable polymers include: polyhydroxyalkonates (PHA), polylactides (PLA), polycaprolactone (PCL) and polybutylene succinate (PBS).

PBS, short for Polybutylene Succinate, is a thermoplastic polymer resin of the polyester family. PBS and its structural analogues are mainly produced by the polycondensation of succinic acid and 1, 4-butanediol or of similar diacids and diols. PBS is a fully bio-degradable material with an excellent biodegradability, breaking down completely to CO2 and H2O under natural conditions. Compared to PHA, PLA and PCL-type degradable polymers, PBS features a good heat resistance and its thermal deformation temperature and product service temperature may even exceed 100° C. It can be manufactured and processed in a desired manner while maintaining excellent mechanical properties. It is pointed out in a monograph ‘Practical plastics: design of synthetic recipes, modification strategies and examples’ (Chemical Industry Press. China 2019) that PBS is the only biodegradable plastic whose overall performance parallels that of the traditional petroleum-based plastics (polyethylene PE, polypropylene PP and polystyrene PS, etc.). PBS has a broad prospect for applications in packaging, tableware, medical equipment, agriculture films, controlled release and biomedical materials and represents one of the ultimate solutions that will effectively solve the plastic pollution in the future. The raw materials for the synthesis and production of PBS can be obtained from fermentation processes of bioresources or, alternatively, from downstream products derived from petroleum and natural gas reserves.

Among the currently reported methods for PBS production, a majority have used succinic acid and 1, 4-butanediol. Multiple patents and academic publications have reported the production of PBS via polycondensation of succinic acid and 1,4-butanediol using different catalysts and process conditions; however, the molecular weight of the PBS product is usually low in all prior art. For example, Tsinghua University filed a patent CN 103710399A (2014 Apr. 9), where polycondensation of butanediol and succinic acid or its derivative (at least one from succinic acid, dimethyl succinate or diethyl succinate) gave PBS products with a relatively low molecular weight, specifically, weight-averaged molecular weight (Mw) of 48000-61000, number-averaged molecular weight (Mn) of 35000-48000 and polydispersity index (PDI) of 1.4-1.6. U.S. Pat. No. 5,310,782A reported a method to synthesize aliphatic polyesters from condensation of aliphatic diacids and aliphatic diols with molecular weight of only about 30,000. Some researchers attempted to tackle the ubiquitous problem that PBS products are usually of relatively low molecular weight by adding chain extenders. For instance, several US patents (U.S. Pat. Nos. 5,391,633, 5,348,700 and 5,525,409) reported the use of isocyanate compounds as chain extender to increase the molecular weight of the produced PBS. With this method, the weight-averaged molecular weight (note: all molecular weights described below are Mw) as high as 170,000 could be achieved. However, this method uses rather toxic isocyanates as the chain extender, and thus the acute toxicity of isocyanate monomers remaining in the product render this type of PBS material of limited use. A China patent CN101328261A documented that by using a catalyst comprised of cesium salt-antimony glycolate, the molecular weight of PBS could reach 56000 to 125000, though the drawbacks of this method include the plentiful low molecule weight side products and the low yield of a PBS product with desirable Mw. Another China patent CN1424339A reported a PBS product with Mw of about 100000 and good mechanical properties, but it did not mention the color and other aspects of the product obtained. There is also patent literature such as CN103724599A, where succinic anhydride and 1,4-butanediol were used to produce PBS of Mw=96,000-130,000 in the presence of catalysts.

Summarizing the above patent literature, the production of PBS via polycondensation of succinic acid and its anhydride with butanediol is usually plagued with problems such as low esterification rates, low PBS molecular weights, inferior color characteristics, subpar mechanical properties and poor processability. Moreover, incomplete condensation reactions result in low yields of desired product, while cyclization of 1, 4-butanediol leads to the formation of a huge amount of tetrahydrofuran as by product. Further, diacids (such as succinic acids) and the monoacids formed during the reaction process are highly corrosive to the reactor equipment, significantly increasing the investment and indirectly adding to the production cost of PBS.

Numerous researchers have devoted to solving these problems, that is, corrosion of the equipment by succinic acid and its anhydride, high residual acid quantities in the PBS product, unstable and irreproducible quality of the PBS product. For example, a China patent CN101935391A reported a method to synthesize high molecular weight aliphatic polyesters; succinates and aliphatic diols were used as raw materials, with the addition of 0.05-0.5% multi-component catalyst, and a two-step condensation to produce PBS with Mw of 54,000-215,000. In another China patent, CN102218949B, dimethyl succinate and 1,4-butanediol were reacted, in a two-step condensation process, in the presence of a multi-component catalytic system, to produce PBS with Mw of 110,000-130,000. Similarly, CN102746493B employed bio-based dimethyl succinate and 1,4-butanediol, two-step condensation, 0.001-1% multi-component catalyst, to synthesize PBS with Mw of 130,000-189,000. CN102718950B reported that PBS with Mw of 100,000-145,000 could be obtained by two-step condensation of dialkyl (methyl, ethyl and propyl) succinates and 1,4-butanediol, with successive addition of catalysts in each step.

The molecular weight of PBS primarily determines its mechanical performance and processability. Generally speaking, the higher the molecular weight of PBS is, the better the overall performance will be. The PBS products described above in the prior patent literature do not yet have a satisfactory molecular weight and performance. As a consequence, data about mechanical performance tests and machining performance tests were not provided in those patents.

With the constant societal development of China and the improving living standards of its people, China will no longer tolerate the further spread of plastic wastes and is determined to go strong for biodegradable plastics. Thus, the biodegradable plastics have a huge potential market in China. According to the current statistics, it is estimated that we are potentially faced with the following needs in different application areas of PBS: approximately 450,000 tons/yr of agricultural films; approximately 5.5 million tons/yr of packaging films, including single-use films for domestic use and medical purposes; approximately 6.5 million tons/yr of plastic bowls and containers for food (instant noodles and fast food), degradable plastic containers, single-use tableware made of foamed plastics, etc.; 90000 tons/yr of packaging materials made of foamed plastics. Together, they add up to a market with an annual consumption of nearly 14 million tons/yr for the degradable plastics. As a biodegradable plastic with arguably the best overall performance, PBS is destined to account for a considerable share in this market. Some have estimated that PBS consumption will reach 3 million tons/yr in China alone. Therefore, a large-scale process for the production of high-quality PBS is urgently needed to cope with the upcoming needs for degradable plastics in the consumer market.

### SUMMARY OF THE INVENTION

In view of the prior art, a technical problem to be solved by the present invention is to provide a method for preparing the synthesis of high molecular weight PBS, which is urgently needed and difficult to produce in large quantities based on existing technologies. This invention uses a new source of raw bulk feedstocks, and circumvents or overcomes problems associated with the acidic monomer's corrosiveness, excessive formation of by-products, low yields of desired products and the relatively low molecular weight of the PBS produced by the existing technologies.

To solve the above technical problem, the method for preparing high molecular weight polybutylene succinate (PBS), comprises: (1) using maleic anhydride (MAH) and C1-C4 alcohols to produce dialkyl maleates; (2) selective hydrogenation of dialkyl maleates obtained in step 1 in the presence of high pressure hydrogen to produce the corresponding dialkyl succinates; (3) condensation of dialkyl succinates with mostly 1,4-butanediol (BDO) and other aliphatic diols to produce high molecular weight PBSs by adding catalysts.

Preferably, the aliphatic alcohols used in step 1 to react with maleic anhydride (MAH) include C1-C4 alcohols such as methanol, ethanol, propanol, etc.; an esterification process in which MAH reacts with alcohols to produce dialkyl maleates and water; an esterification process that occurs at temperatures of 70-150° C. and absolute pressures of 20-200 kPa with a reaction time of 0.1-16 hours; the catalyst used for such an esterification process includes at least one of sulfuric acid, p-toluenesulfonic acid or sulfonic acid resin; the intermediate products after purification contain 50%-99.5% of dialkyl maleates.

The reactants in the abovementioned esterification are MAH and methanol, ethanol, propanol, etc. For example, the reaction of MAH and methanol occurs via the equations (1) and (2):

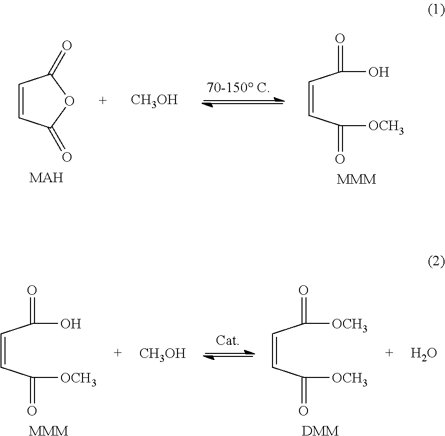

These two esterification reactions are both reversible and can happen spontaneously without catalysts. As water is produced in both reactions, a reactive distillation process is typically used with catalysts, especially reaction (2), to remove the produced water and excessive alcohol. The catalysts used for reactions above are at least one of sulfuric acid, p-toluenesulfonic acid or sulfonic acid resin. The esterification processes occur at temperatures of 70-150° C. and absolute pressures of 20-500 kPa with a reaction time of 0.1-16 hours. The reactors and purification equipment include reaction kettle, pre esterification reactor, rectifying tower for the separation of water and alcohol, flash distillation tower, reactive distillation reactor, rectifying towers, etc. After reactions, the produced dialkyl maleates such as DMM can reach a concentration of 50-99.5% with excessive alcohol beneficially for further use.

Preferably, the selective hydrogenation described in step (2) comprises: selective hydrogenation of the C═C bond in dialkyl maleates in the presence of high pressure hydrogen to produce dialkyl succinates, which occurs at temperatures of 50-350° C. and absolute pressures of 0.2-6.0 MPa for 0.01-14 h. The reactors used for the selective hydrogenation of dialkyl maleates include hydrogenation autoclaves, fixed bed reactors and tubular reactors. The production equipment also includes rectifying towers for purification of dialkyl succinates. After distillations to remove light components and heavier components, the products contain at least 99.5% of dialkyl succinates. The catalyst used for such a process includes, but is not limited to, at least one of Raney nickel or supported platinum, palladium and other noble metal catalysts.

Selective hydrogenation reactions described above use different dialkyl maleates with specified purities, including dimethyl maleate (DMM), diethyl maleate (DEM), dipropyl maleate (DPM), etc. All the dialkyl maleates mentioned above can be hydrogenated to the corresponding dialkyl succinates. For example, the hydrogenation of DMM to DMS is described in equation (3).

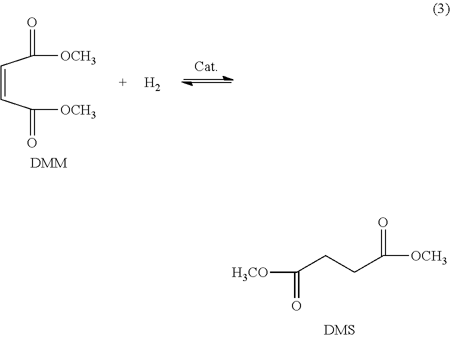

Preferably, the aliphatic diols used to produce high molecular weight PBSs described in step (3) include, but are not limited to: 1,4-butanediol (BDO) in most cases, as well as ethylene glycol, 1,6-hexanediol and other aliphatic diols.

Preferably, the catalysts used for the trans-esterification and polycondensation process to produce high molecular weight PBSs include one or more compounds among p-toluene sulfonic acid, tetrabutyl titanate, nano titanium dioxide, BDO-titanium complexes and nano titanium silicon oxide.

Further, dialkyl succinates and the aliphatic diols react under N2 protection, 150-200° C. for the first 2-4 hours and then 200-260° C. for the ensuing 2-5 hours under absolute pressure of 50-500 Pa to produce high molecular weight PBSs.

Dimethyl succinate (DMS), diethyl succinate (DES), dipropyl succinate (DPS) and aliphatic diols such as 1,4-butanediol (BDO), ethylene glycol (EG), propylene glycol, etc., can react in the polymerization kettle with the aid of a specific catalyst, and the high molecular weight PBS is obtained from transesterification and polycondensation/polymerization. For example, the polymerization of DMS and BDO is described in equation (4).

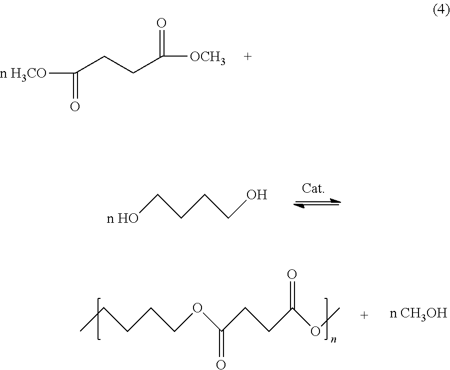

Continuous extraction of methanol generated from trans-esterification is required to drive the reaction to near completion. For DES or DPS as raw materials, short-chain fatty alcohols such as ethanol and propanol generated from trans-esterification should be continuously extracted during the reaction. The catalysts selected for the reaction are one or more of p-toluene sulfonic acid, tetrabutyl titanate, nano-titanium dioxide, titanium compounds and titanium silicon compounds. The molar ratios of dialkyl succinates to the aliphatic diols in the reaction are preferably 1:1.0-1.5, preferably, 1:1.0-1.2. The weight of catalysts used for the reaction is 0.1-1.0% weight of the monomers. The reactor can be a conventional batch polymerization reactor or series tubular reactor or multiple polymerization reactors.

The technical route of the invention can also fine-tune the process conditions to produce PBSs with different mechanical properties, different molecular weight distributions and different melting indices for different applications such as wire drawing, tape film casting, injection molding and film blowing. These include adjustments of the reaction temperature and reaction time, the molar ratio of the raw materials (monomers dialkyl succinates and aliphatic diols, mainly BDO), the addition of different amounts of hard monomer ethylene glycol and soft monomer hexanediol.

Compared with the existing technologies, the present invention has the following advantages:

(1) The technical route of the present invention is the most economical and efficient process route compared with other routes, which employs maleic anhydride (MAH) as the initial raw material and synthesizes dialkyl succinates through esterification and selective hydrogenation. The abundance of MAH and the raw materials for making MAH ensures that sufficient raw materials are available for the synthesis of PBSs via the present route. Traditional routes for PBS production use succinic acid as the reactant; however, succinic acid produced either by electrolysis or by biological methods not only demands a high energy consumption and serious equipment corrosion, but also has disadvantages such as a great difficulty in separation and purification, low quality and high costs. The output of succinic acid nationwide (China) is only 30-40 thousand tons. The production of dialkyl succinates from other processes in China is less than 10 thousand tons per year. The raw materials of MAH can be n-butane or pure benzene, which are abundantly available. Now MAH has become a bulk chemical with one million tons production scale in China, with its national production capacity of more than 2 million tons per year and the annual output of more than 1.5 million tons. Large companies are still actively expanding their production. Another monomer used in the PBS production, 1,4-BDO, also has an annual production capacity of 2 million tons in China. This provides a basic guarantee for the future development of more than millions of tons of PBS in China.

(2) The technical route of this invention selects and uses a variety of catalysts with high activity in the polymerization-transesterification reaction, which is easy to operate, uses less catalysts, and is more cost-saving. Moreover, because of the few side reactions and high yields in the polymerization stage, PBS products with high molecular weight can be obtained in a short time, which is beneficial to improve the production efficiency. In the meantime, because THF (via the cyclization side reaction of BDO) is produced in very small quantities, the lower fatty alcohols such as methanol from transesteration can be recycled to the esterification stage of maleic anhydride after simple purification.

(3) A high molecular weight PBS is synthesized via the technical route of the present invention. According to the molecular weight determined by GPC, its weight-averaged molecular weight Mw value is over 250,000, the maximum being over 300,000, and the molecular weight distribution Mw/Mn value is between 1.4-3.0. The PBS prepared by the present invention is white in color and has good heat resistance and mechanical properties: the melting point is 110-130° C., the thermal deformation temperature is over 100° C., the fracture strength is 27-40 MPa, the bending strength is 38 MPa, the bending modulus is 700 MPa, the impact strength is 4-15 kJ/m2, and the machining performance is also very excellent. The technical route can also fine-tune the synthesis process and raw materials to produce PBS applicable for different purposes such as drawing and tape casting film, injection molding and blowing film, etc.

(4) The dialkyl succinate monomer selected is much less acidic than that of succinic acid and succinic anhydride. The demand is reduced for metal materials in the polymerization segment, which cuts down a great deal of costs for equipment investment and maintenance, and thus reduces production costs.

To sum up, the invention uses maleic anhydride as one of the starting raw materials to replace the more acidic monomer used in the conventional route for PBS production. With MAH and the aliphatic alcohols, mostly BDO and diols, the synthesis via transesterification and polycondensation is realized by using the selected highly efficient catalyst. Using the process disclosed in this invention, high molecular weight PBSs with good chroma, excellent mechanical property and good machining property can be synthesized.

### BRIEF DESCRIPTION OF THE DRAWINGS

FIG. 1 is DSC test results of commercial PBS and PBSs in Example A1 and A2.

### DETAILED DESCRIPTION OF THE INVENTION

The present invention will be further described below in detail with reference to the accompanying drawings by embodiments.

### Example A1

(1) Synthesis of Dimethyl Maleate (DMM)

1470 g (15 mol) of solid maleic anhydride was added in a 2500 ml three necked glass flask, together with some Φ3 mm ceramic rings and a magnetic stirrer. A thermometer, a stinger reflux glass tube and a water-cooled collection system were equipped with the glass flask. The flask was heated in an oil bath. After the inside temperature reached 55° C. when all solid maleic anhydride melted, 15 g of 98% H2SO4 was added into the flask while stirring. Then, 550 g (17.2 mol) of methanol was pumped using a peristaltic pump through a glass tube into the flask at the bottom. The reaction then vigorously occurred with a substantial amount of heat released. The reaction temperature was maintained to be 70-80° C., which was controlled by cooling reflux and methanol adding rate. After one hour, all the methanol was pumped in and the temperature was kept at 80° C. for another hour. After that, pumping of methanol was started again and the reaction temperature was raised to 120° C. During the following reaction process, a large quantity of methanol would be consumed and a large volume of the methanol-water mixture would flow out by distillation and cooling. Methanol in such a mixture could be recovered by distillation. After 3-5 hours, samples were taken periodically and analysis was done by gas chromatography. When the maleic anhydride was consumed and the remaining monomethyl maleate was less than 0.5 w %, the reaction was stopped. After cooling, the reaction mixture was poured into a 2500 ml beaker containing 500 ml of water. And that, 4 mol/L NaOH solution was added into the mixture, and the solution pH was neutralized to 6-9. Then, the stirring was stopped, and oil phase and water phase was separated. 2200 g of the oil phase was collected and analyzed with gas chromatography, and the results are shown in table 1.

(2) Synthesis of Dimethyl Succinate (DMS) in an Autoclave

2000 g of the oil phase collected in the step 1 was added into a 2.5 L stainless steel autoclave, together with 10 g of Pd/C catalyst, in which the palladium loading was about 10%. After exchanging the headspace gas with 500 kPa of N2 for three times, the autoclave was pressurized with hydrogen to 4.0 MPa. And then, the stirring was started, and the temperature was set to 120° C. At that temperature, hydrogen was continuously fed for 12 hours. After taking samples and analysis with GC, until a point when the conversion of DMM (DFM) reached 99.7%, heating was stopped, and thus the reaction was terminated. After cooling and collecting the reaction mixture by filtering, a distillation tower was used for purification of the oil phase collected. Our GC analysis showed that we collected 1850 g of DMS with a concentration of 99.5%.

(3) Synthesis of PBS for Use as Tape Casting Films

877 g (6 mol) of dimethyl succinate (DMS) obtained from step 2, 595 g (6.6 mol) of 1,4-butanediol (BDO) and 0.3 g of p-toluene sulfonic acid and 0.45 g of tetrabutyl titanate were added in a 316L stainless steel autoclave for polymerization reactions. This autoclave was equipped with heating, stirring, temperature controlling and vacuum components. The reaction was carried out under nitrogen atmosphere with the stirring rate set to 50 r/min. The reactor was first maintained at 140° C. and ambient pressure for 3 hours for the transesterification and the distilled methanol was collected. After that, the reaction temperature was raised to 240° C., then a vacuum of <50 Pa was applied, and the temperature was maintained for 2.5-3.5 hours. When the power of the stirring motor exceeded 75 W, the reaction was stopped. The PBS product was released to the water tank by pressurizing the autoclave under N2. After drying, 831 g of PBS was obtained. According to the analysis by gel permeation chromatography (GPC), the PBS has a Mw of 250,000 and the Mw/Mn is 2.5. The mechanical properties, melting point and melt index of the PBS obtained in this case are shown in Tables 3 and 4. Such PBS is white and has good fluidity. Even at 150° C., its melt flow index is higher than 60 g/10 min (2.16 kg load). Tests have proven that this product is suitable for manufacturing tape casting film and also for melt spinning. Such PBS can be mixed with 50% in weight of CaCO3 that endows the material with a higher rigidity.

### Example A2

(1) Synthesis of Dimethyl Maleate (DMM):

The selected catalyst was 30 g of p-toluenesulfonic acid. Other conditions and steps were identical to those for DMM synthesis in Example A1.

(2) Synthesis of Dimethyl Succinate (DMS) in an Autoclave:

The selected catalyst was 50 g of Raney nickel and the reaction temperature was 180° C. Other conditions were the same as those detailed in Example A1.

(3) Synthesis of General-Purpose High Molecular Weight PBS:

1080 g (7.5 mol) of DMS obtained from step 2, 878 g (9.75 mol) of 1,4-butylene glycol (BDO), 0.5 g of tetrabutyl titanate and 0.5 g of nano titania-silica composite oxide (TiO2/SiO2 molecular ratio being 50:50) as the catalyst were added in the autoclave for polymerization reactions. This autoclave was equipped with heating, stirring, temperature controlling and vacuum components. The reaction was carried out under nitrogen atmosphere with the stirring rate set to 50 r/min. The reactor was first maintained at 180° C. and ambient pressure for 3-4 hours for the transesterification, while the distilled methanol and other side products were collected. After that, the reaction temperature was raised to 250° C., then a vacuum of <50 Pa was applied, the temperature was maintained for 4-5 hours, and low-boiling substances were distilled. When the power of the stirring motor exceeded 75 W, the stirring speed was adjusted to 25 r/min. When the stirring power reached 75 W again, the reaction was stopped. The PBS product was released to the water tank by pressurizing the autoclave under N2. After drying, 1060 g of PBS was obtained. The product yield was about 86.8%. According to the analysis by GPC, the PBS has a Mw of 285,000 and the Mw/Mn is 1.8. The mechanical properties, melting point and melt index of the PBS obtained in this case are shown in Tables 3 and 4. It should be pointed out that PBS also has very good mechanical properties with pure white color and good processability, which can be completely processed by traditional equipment, capable of replacing traditional general-purpose plastics.

### Example A3

(1) Synthesis of Dimethyl Maleate (DMM):

The selected catalyst was 100 g of sulfonic acid resin. The catalyst was filtered and recovered after reaction, and the methanol content of the DMM obtained after final distillation was 50%. Other conditions and steps were identical to those for DMM synthesis described in example A1.

(2) Synthesis of Dimethyl Succinate (DMS) in an Autoclave: identical to Example A1.

(3) Synthesis of High Molecular Weight PBS for Film Blowing:

1095 g (7.5 mol) of DMS, 540 g (6 mol) of BDO, 186 g (3.0 mol) of ethylene glycol (EG), 0.6 g of tetrabutyl titanate and 0.6 g of nano titanium dioxide were added in the autoclave for polymerization reactions. This autoclave was equipped with heating, stirring, temperature controlling and vacuum components. The reaction was carried out under nitrogen atmosphere with the stirring rate set to 50 r/min. The reactor was first maintained at 170° C. and ambient pressure for 3-4 hours for the transesterification and the distilled methanol and some side products were collected. After that, the reaction temperature was raised to 250° C. and a vacuum of <50 Pa was applied. The temperature was maintained for 4-5 hours, and low-boiling substances were distilled. When the power of the stirring motor exceeded 75 W, the stirring speed was adjusted to 25 r/min. After the stirring power reached 75 W again, the stirring speed was further decreased 12 r/min and finally, when the stirring power became 60 W, the reaction was stopped. The PBS product was released to the water tank by pressurizing the autoclave under N2. After drying, 1040 g of PBS was obtained. The product yield was about 80.6%. According to the analysis by GPC, the PBS has a Mw of 353,000 and the Mw/Mn is 1.4. The mechanical properties, melting point and melt index of the PBS obtained in this case are shown in Tables 3 and 4. It should be noted that the PBS is pure white in color and has very good mechanical properties, and its tensile strength is 38.5 MPa. In addition, the PBS has a good processability and can be processed by traditional film blowing equipment, replacing conventional non-degradable plastics in general use.

### Example B1

(1) Synthesis of dimethyl maleate (DMM): identical to example A1.

(2) Hydrogenation of DMS in a Fixed-Bed Reactor:

Four different catalysts were used in the hydrogenation of the mixture of DMM and methanol in a fixed-bed microreactor. The diameter of the reactor was Φ14 mm. The amount of catalyst used was 10 g, the reaction temperature was 270° C., the liquid mass flow rate was 1.5 h-1, the reaction pressure was 4.0 MPa, and the hydrogen to DMM molar ratio was 4:1. The products were analyzed by GC, and the conversion and product selectivities were calculated. The specific product parameters obtained with different catalysts are shown in Table 2.

(3) Synthesis of General-Purpose High Molecular Weight PBS:

Conditions and steps identical to those described in Example A2 were adopted and the test results of product performance were approximately the same as Example A2.

### Example B2

(1) Synthesis of dimethyl maleate (DMM): identical to example A1.

(2) Hydrogenation of DMS in a Fixed-Bed Reactor:

The conditions were similar to those of Example B1, but the reaction temperature was 190° C., the liquid mass flow rate was 1.0 h-1, the reaction pressure was 3.0 MPa, and the hydrogen to DMM molar ratio was 6:1.

(3) Synthesis of General-Purpose High Molecular Weight PBS:

1080 g (7.5 mol) of DMS obtained from step 2, 878 g (9.75 mol) of 1,4-BDO, 177 g (1.5 mol) of 1,6-hexanediol (HDO), 0.5 g of tetrabutyl titanate and 1.0 g of titanium glycolate were added in the autoclave for polymerization reactions. This autoclave was equipped with heating, stirring, temperature controlling and vacuum components. The reaction was carried out under nitrogen atmosphere with the stirring rate set to 50 r/min. The reactor was first maintained at 180° C. and ambient pressure for 3-4 hours for the transesterification and the distilled methanol and side products were collected. After that, the reaction temperature was raised to 250° C., and a vacuum of <50 Pa was applied. The reactor was maintained at 250° C. for 4-5 hours, and low-boiling substances were distilled off. When the power of the stirring motor exceeded 75 W, the stirring speed was set at 25 r/min. After the stirring power reached 75 W again, the reaction was stopped. The PBS product was released to the water tank by pressurizing the autoclave under N2. After drying, 1230 g of PBS was obtained. The test results of product performance were approximately the same as Example A2.

### Example B3

(1) Synthesis of dimethyl maleate (DMM): identical to example A1.

(2) Hydrogenation of DMS in a fixed-bed reactor: identical to example B2.

(3) Synthesis of General-Purpose High Molecular Weight PBS:

1080 g (7.5 mol) of DMS obtained from step 2, 540 g (6.0 mol) of 1,4-BDO, 102 g (1.65 mol) of ethylene glycol, 0.2 g of tetrabutyl titanate and 0.2 g of titanium glycolate were added in the autoclave for polymerization reactions. This autoclave was equipped with heating, stirring, temperature controlling and vacuum components. The reaction was carried out under nitrogen atmosphere with the stirring rate set to 50 r/min. The reactor was first maintained at 180° C. and ambient pressure for 4-10 hours for the transesterification and the distilled methanol and side products were collected. After that, the reaction temperature was raised to 250° C., and a vacuum of <50 Pa was applied. The temperature was maintained for 4-5 hours. When the power of the stirring motor exceeded 75 W, the stirring speed was adjusted to 25 r/min. When the stirring power reached 75 W again, the reaction was stopped. The PBS product was released to the water tank by pressurizing the autoclave under N2. After drying, 1030 g of PBS was obtained. The test results of product performance were approximately the same as Example A3.

### Example C

(1) Synthesis of diethyl maleate (DEM): The methanol of Example A1 was replaced by ethanol, and the others were consistent with Example A1.

(2) Hydrogenation of Diethyl Maleate (DEM) in a Fixed-Bed Reactor:

Diethyl succinate (DES) was synthesized by selective hydrogenation of 99.5% diethyl maleate (DEM) in a fixed-bed microreactor using (0.25% Pt+0.25% Pd)/(Al2O3-SiO2) as the catalyst. The diameter of the reactor was Φ 14, the amount of catalyst, reaction temperature, the weight hourly space velocity of DEM, reaction pressure, the molar ratio of hydrogen to DEM were 12 g, 290° C., 1.5 h-1, 3.0 MPa and 5:1, respectively. The conversion and selectivity to diethyl maleate were 99.5% and 99.0%, respectively. After distillation, the purity of diethyl succinate was greater than 99.7%.

(3) Synthesis of High Molecular Weight PBS for Injection Molding:

1305 g (6 mol) of DES obtained from step 2, 540 g (6.0 mol) of 1,4-BDO, 186 g (3.0 mol) of ethylene glycol (EG), 0.6 g of tetramethylene titanate and 0.6 g of titanium butanediolate were added into the autoclave for polymerization reactions. This autoclave was equipped with heating, stirring, temperature controlling and vacuum components. The reaction was carried out under nitrogen atmosphere with the stirring rate set to 50 r/min. The reactor was first maintained at 150° C. and ambient pressure for 3 hours for transesterification and the distilled ethanol and side products were collected. After that, the reaction temperature was raised to 250° C., and a vacuum of <50 Pa was applied. The temperature was maintained for 3.5-5 hours, and the low-boiling substance was steamed. When the power of the stirring motor exceeded 75 W, the stirring speed was set at 25 r/min. When the stirring power reached 75 W again, the reaction was stopped. The PBS product was released to the water tank by pressurizing the autoclave under N2. After drying, 1088 g of PBS was obtained. The product yield was about 85%. GPC analysis showed that its weight-average Mw value was 303,000, and its Mw/Mn value was 1.6. The test results of product performance were approximately the same as Example A2.

Performance Testing and Analysis:

(1) The high molecular weight PBS obtained from example A, B and C was crushed by a Φ 45 mm twin-screw granulation, showing its good granulation processing performance. Part of the material also was also used for filler mixed granulation. The high molecular weight PBS after granulation was used to conduct injection molding tests on an injection molding machine. PBS obtained in example A3 after granulation was also used to attempt at film blowing on a film-blowing machine. And it was subjected to twin-screw extrusion granulation, put on an injection molding machine for injection experiment, and a trial film-blowing of PBS was conducted on the film-blowing machine. The subsequent mechanical performance test results proved that the high molecular weight PBS produced by the process in this invention has excellent processing performance, mixing modification performance and excellent mechanical properties

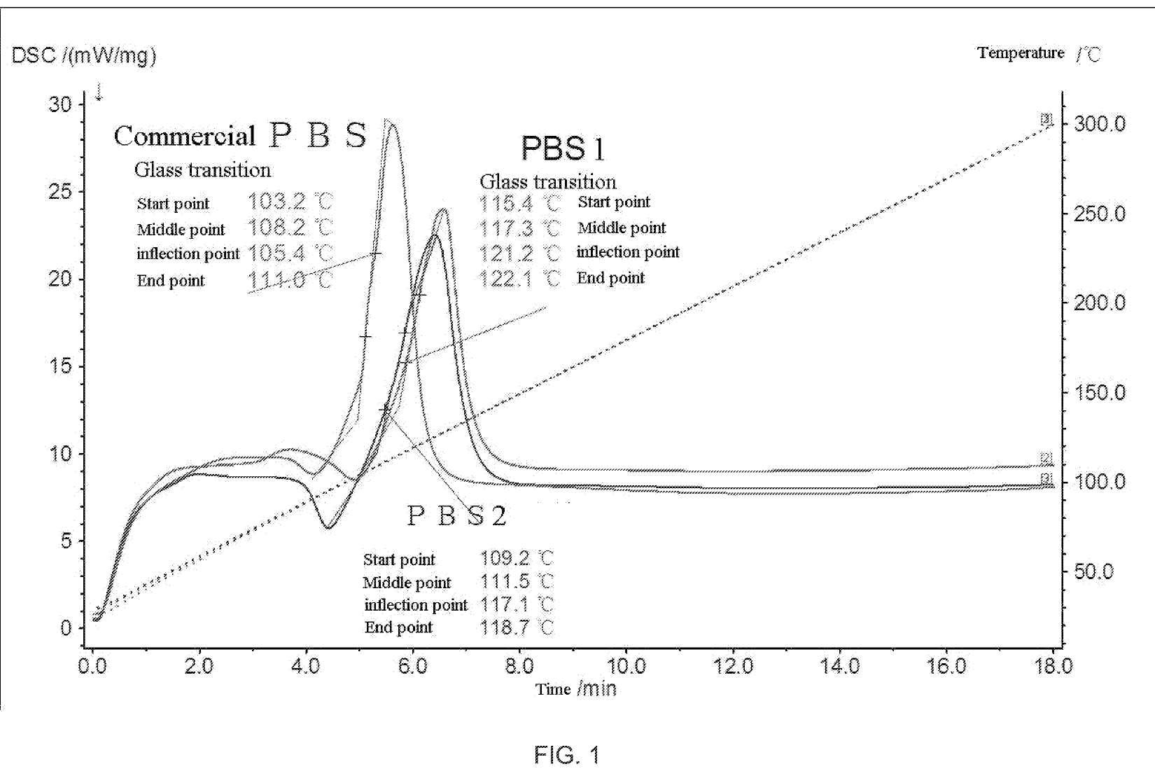

(2) For comparison, DSC tests were also performed with a certain commercial PBS material sold in a domestic market (molecular weight 110,000) and with our synthesized high molecular weight PBS; in both cases, the sample amount was 26 mg. The specific test results are shown in FIG. 1. PBS1 is the sample after granulation of example A1, and PBS2 is the sample after granulation of example A2. It can be seen that the melting point of our synthesized high molecular weight PBS was nearly 10° C. higher than the commercial PBS, which means a better heat resistance of our high molecular weight PBS material.

TABLE 1
Example A1 Contents of the compounds used
to synthesize the reaction intermediate DMM

| | | dimethyl | dimethyl | |
|---|---|---|---|---|
| | methanol | fumarate | maleate | Other |
| Components | (MeOH) | (DMF) | (DMM) | impurities |
| Content (w %) | 10 | 3.20 | 86.0 | 0.8 |

TABLE 2
DMM conversion and DMS selectivity obtained
with different catalysts used

| | DMM (DMF) | Selectivity |
|---|---|---|
| | conversion | to DMS |
| Catalysts | (%) | (%) |
| 0.5%Pt/Al₂O₃ | 99.5 | 99.0 |
| 0.3%Pd/Al₂O₃ | 98.6 | 99.5 |
| (0.25%Pt + 0.25%Pd)/Al₂O₃ | 99.5 | 99.4 |
| (0.25%Pt + 0.25%Pd)/(Al₂O₃—SiO₂) | 99.5 | 99.0 |

TABLE 3
Mechanical properties of the PBS products

| | | | | Notched |
|---|---|---|---|---|
| | Tensile | Elongation | Elastic | Izod |
| | strength, | at break | modulus, | Impact, |
| PBS samples/performance | (MPa) | (%) | MPa | kJ/m² |
| PBS described in Example | 27.2 | 450 | 295 | 9 |
| A1 | | | | |
| PBS of Example | 17.7 | 30 | 588 | 6 |
| Al + 50%CaCO₃ | | | | |
| PBS described in Example | 37.5 | 320 | 286 | 12 |
| A2 | | | | |
| PBS described in Example | 38.5 | 340 | 386 | 12 |
| A3 | | | | |
| PBS described in Example | 40.2 | 300 | 305 | 14 |
| C | | | | |

TABLE 4
Melting point and melt index of the PBS products (2.16 kg load)

| | Melting point | Melt index, g/10 min | | |
|---|---|---|---|---|
| PBS samples/Performance | (° C.) | 130° C. | 150° C. | 190° C. |
| PBS described in Example | 110-115 | 11.0 | >60 | — |
| A1 | | | | |
| PBS of Example | 110-115 | 8.17 | 20.1 | — |
| A1 + 50%CaCO₃ | | | | |
| PBS described in Example | 110-120 | 6.0 | 12.5 | 26.6 |
| A2 | | | | |
| PBS described in Example | 115-130 | 1.18 | 4.20 | 7.16 |
| A3 | | | | |
| PBS described in Example | 112-125 | 3.75 | 6.79 | 14.2 |
| C | | | | |

1. A method for preparing high molecular weight polybutylene succinate (PBS), comprising:
(a) using maleic anhydride (MAH) and C1-C4 alcohols to produce dialkyl maleates and water, in which dialkyl fumarate is calculated as dialkyl maleate of an equivalent mole, and a reactive distillation process is used for the purification and obtains dialkyl maleates;
(b) selective hydrogenation of those dialkyl maleates in the presence of high pressure hydrogen to produce the corresponding dialkyl succinates;
(c) condensation of dialkyl succinates with mostly 1,4-butanediol (BDO) and other aliphatic diols to produce high molecular weight PBSs by adding catalysts.

2. The method according to claim 1, wherein step a that is the production process of dialkyl maleates comprises: the aliphatic alcohols used to react with maleic anhydride (MAH) include C1-C4 alcohols such as methanol, ethanol, propanol, etc.; an esterification process in which MAH reacts with alcohols to produce dialkyl maleates and water; an esterification process that occurs at temperature 70-150° C. and absolute pressure of 20-500 kPa with a reaction time of 0.1-16 hours; the catalyst used for such a esterification process includes at least one of sulfuric acid, p-toluenesulfonic acid or sulfonic acid resin; the intermediate products after purification contain 50%-99.5% of dialkyl maleates, and the isomer dialkyl fumarate is also calculated as dialkyl maleates.

3. The method according to claim 1, wherein step b that is the production process of dialkyl succinates comprises: the reaction of dialkyl maleates with hydrogen by selective hydrogenation of the C═C bond occurs at temperature 50-350° C. and absolute pressure of 0.2-6.0 MPa; the catalyst used for such a process includes at least one of Raney nickel or supported platinum, palladium and other noble metal catalysts; the products contain at least 99.5% of dialkyl succinates.

4. The method according to claim 1, wherein step c that is the production process of PBSs comprises: the aliphatic diols used to produce high molecular weight PBSs include mostly 1,4-butanediol and also ethylene glycol, 1,6-hexanediol or other aliphatic diols.

5. The method according to claim 1, wherein step c that is the production process of high molecular weight PBSs comprises: a polymerization process which includes trans-esterification and poly-condensation processes occurring by adding catalysts, dialkyl succinates and the aliphatic diols, N₂ protection, 150-200° C. for the first 2-4 hours and then 200-260° C. for the ensuing 2-5 hours under the pressure of 50-500 Pa.

6. The method according to claim 5, wherein the catalysts used for the polymerization process to produce high molecular weight PBSs include one or more compounds of p-toluene sulfonic acid, tetrabutyl titanate, nano titanium dioxide, BDO-titanium complexes and titanium silicon oxide.

7. The method according to claim 5, wherein the polymerization process to produce high molecular weight PBSs comprises: the catalysts whose weight used for the reaction is 0.1-1.0% weight of the monomers, and the molecular ratio of dialkyl succinates and alkyl diols is 1:1.0-1.5.
